(19) United States
(12) Patent Application Publication
(10) Pub. No.: US 2026/0125829 A1
(43) Pub. Date: May 7, 2026

(54) WOVEN FABRIC

(71) Applicant: NBC MESHTEC INC., Tokyo (JP)

(72) Inventors: Masayuki YAMAGUCHI, Tokyo (JP); Makoto TAKIGUCHI, Tokyo (JP); Kaori KAMATA, Tokyo (JP); Shin HASEGAWA, Tokyo (JP); Nobukazu MOTOJIMA, Tokyo (JP)

(73) Assignee: NBC MESHTEC INC., Tokyo (JP)

(21) Appl. No.: 19/117,833

(22) PCT Filed: Oct. 3, 2023
(86) PCT No.: PCT/JP2023/036058

§ 371 Date: Apr. 2, 2025

(30) Foreign Application Priority Data
Oct. 7, 2022 (JP) 2022-162779

(51) Int. Cl. D03D 15/40; H04R 1/28

(52) U.S. Cl. CPC D03D 15/40; D10B 2505/00; H04R 1/2811

(57) ABSTRACT

Provided is a woven fabric that effectively prevents sound leakage to the outside and intrusion of external noise and has little variation in the acoustic property when used as a woven fabric for adjusting the back pressure of a speaker, earphones, and the like. Provided is a woven fabric including a warp thread and a weft thread, the woven fabric having a airflow resistance of 0.3 kPa·s/m or more and 5 kPa·s/m or less, and the woven fabric having a tolerance of the airflow resistance within ±10%. In the woven fabric, at least one of the warp thread and the weft thread is a multifilament thread. In the woven fabric, the multifilament thread is a non-twisted thread without twists.

### TECHNICAL FIELD

The present invention relates to a woven fabric used in an acoustic device such as a speaker or earphones.

### BACKGROUND ART

In general, in an acoustic device such as a so-called closed-type speaker, earphones, or a headphone, an air chamber behind a diaphragm is closed, and movement of a sounding portion (diaphragm) is restricted by a change in atmospheric pressure, so that originally intended sound cannot be generated. Therefore, a back pressure adjustment function called a vent is provided to adjust the pressure (back pressure) inside the device. The vent has a small number of airflow holes for adjusting the back pressure and is required to have a function capable of preventing sound leakage to the outside or preventing intrusion of noise from the outside. Conventionally, an acoustic member that is a plate made of plastic or metal, a film-like fiber structure, or the like and has a airflow property owing to a airflow portion such as a plurality of small holes is attached to the airflow holes connecting the inside and the outside of such an acoustic device.

Patent Literature 1 discloses a laminated fiber structure in which a single thread fiber material is bonded to a polymer film and that is used in an acoustic component, and describes an application example in which the laminated fiber structure is attached to the back side of earphones.

### CITATION LIST

### Patent Literature

Patent Literature 1: JP 2013-526172 A

### SUMMARY OF INVENTION

### Technical Problems

However, the lamination of a fiber structure and a film as in Patent Literature 1 requires a bonding portion between the fiber structure and the film, and a airflow portion is blocked at the bonding portion. When the fiber structure is used in an acoustic device such as small earphones, a part of the fiber structure is cut off from the laminated fiber structure and used, and the number of bonding portions varies depending on the portion to be cut, resulting in a variation in the airflow property. The variation in the airflow property results in problems such as a variation in the acoustic property between the right and left sides of the earphones.

The present invention has been made to solve such conventional problems, and it is an object of the present invention to provide a woven fabric that effectively prevents sound leakage to the outside and intrusion of external noise and has little variation in the acoustic property when used as a woven fabric for adjusting the back pressure of a speaker, earphones, and the like.

### Solution to Problems

The gist of the present invention is as follows.

(1) A woven fabric including a warp thread and a weft thread, the woven fabric having a airflow resistance of 0.3 kPa·s/m or more and 5 kPa·s/m or less, and the woven fabric having a tolerance of the airflow resistance within ±10%.

(2) The woven fabric according to (1), wherein at least one of the warp thread and the weft thread is a multifilament thread.

(3) The woven fabric according to (1), wherein the warp thread and the weft thread are multifilament threads.

(4) The woven fabric according to (2) or (3), wherein the multifilament thread is a non-twisted thread without twists.

(5) The woven fabric according to (2) or (3), wherein a single thread that constitutes the multifilament thread has a cross-sectional shape that is any of a circular shape, an elliptical shape, a polygonal shape in which each internal angle is less than 180 degrees, and a substantially polygonal shape in which each corner of the polygonal shape has an R shape.

(6) The woven fabric according to (2) or (3), wherein a variation in an apparent thread diameter of the multifilament thread when the woven fabric is viewed from a airflow direction thereof is 5% or less.

(7) The woven fabric according to any one of (1) to (3), which is dutch woven, twill woven, or twill dutch woven.

(8) The woven fabric according to any one of (1) to (3), which is used as a woven fabric for adjusting the back pressure of an acoustic device.

(9) The woven fabric according to (1), wherein the warp thread and the weft thread have a thread diameter of 30 μm or more and 100 μm or less.

(10) The woven fabric according to (1), having an opening (OP) of 20 μm or less.

(11) The woven fabric according to (1), having an opening area (OPA) of 15% or less.

### Advantageous Effects of Invention

According to the present invention, it is possible to provide a woven fabric that effectively prevents sound leakage to the outside and intrusion of external noise and has little variation in the acoustic property when used as a woven fabric for adjusting the back pressure of a speaker, earphones, and the like.

### BRIEF DESCRIPTION OF DRAWINGS

FIG. 1 is a configuration diagram illustrating a configuration of a woven fabric 1 of the present embodiment.

FIG. 2 is a drawing illustrating a part of a multifilament thread when the woven fabric 1 is viewed from the airflow direction thereof.

### DESCRIPTION OF EMBODIMENTS

In the following, embodiments of the present invention are described in detail. The woven fabric of the present embodiment can be used as an acoustic woven fabric for blocking airflow holes of an acoustic device such as a speaker or earphones while maintaining the airflow property although the application is not limited. The woven fabric of the present embodiment is suitable as an acoustic woven fabric for adjusting the back pressure disposed so as to block airflow holes connecting the inside and the outside of an acoustic device in order to adjust the back pressure, particularly in an acoustic device such as a closed-type speaker or earphones. Furthermore, the woven fabric of the present embodiment can also be used, for example, as a waterproof cloth that prevents intrusion of liquid to the inside of an acoustic device, a dust-proof cloth that prevents intrusion of dust and the like, and a member of an acoustic device such as a speaker. The woven fabric is cut into a shape corresponding to an attachment position on an acoustic device and used for these various applications.

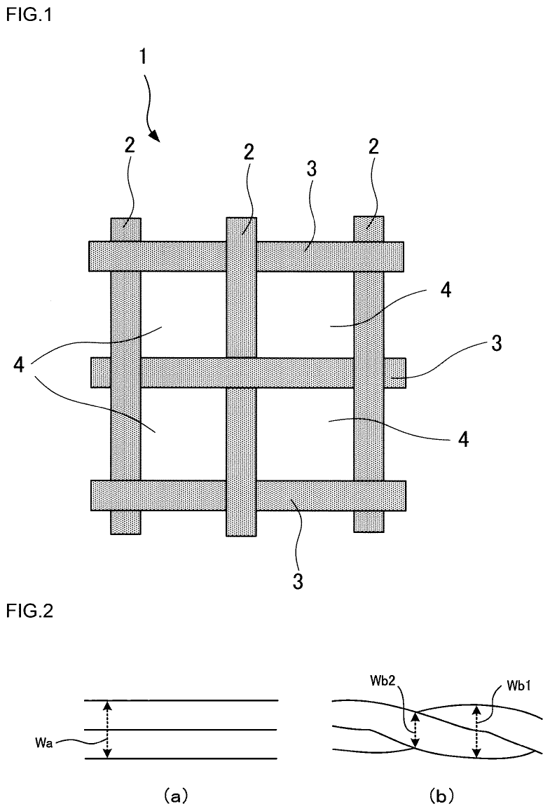

FIG. 1 is a configuration diagram illustrating a configuration of a woven fabric 1 of the present embodiment. The woven fabric 1 is formed by weaving warp threads 2 and weft threads 3, and the woven fabric 1 in FIG. 1 is a plain woven fabric as an example. The woven fabric 1 has a plurality of voids 4 formed by crossing the warp threads 2 and the weft threads 3. When the woven fabric 1 is disposed on airflow holes of an acoustic device such as a speaker or earphones, air is ventilated through the voids 4, and the back pressure adjustment is performed when the woven fabric is for adjusting the back pressure. The woven fabric 1 has a predetermined airflow resistance depending on the number and size of the voids 4. The size and shape of the voids vary depending on various conditions such as the materials of the warp threads 2 and the weft threads 3, whether the warp threads 2 and the weft threads 3 are monofilaments or multifilaments, and the thread diameter, and the airflow resistance also varies accordingly. In FIG. 1, the voids 4 are illustrated to be large with respect to the diameters of the warp threads 2 and the weft threads 3 for easy understanding, but in the actual woven fabric 1, the threads are tightly packed and the voids 4 are smaller.

### (Tolerance of Airflow Resistance)

The woven fabric 1 of the present embodiment has a tolerance of the airflow resistance within ±10%. The woven fabric 1 that has a tolerance of the airflow resistance within ±10% means a woven fabric in which an allowable error with respect to a designed value (predetermined reference value) of the airflow resistance is within ±10% of the designed value (predetermined reference value). The tolerance of the airflow resistance within ±10% is preferable because such tolerance results in a small variation in the acoustic property when the woven fabric 1 of the present embodiment is used for adjusting the back pressure of an acoustic device such as a speaker or earphones. The tolerance of the airflow resistance of more than ±10% results in an increase in the variation in the acoustic property in an acoustic device.

In order to confirm whether or not the woven fabric 1 satisfies the tolerance condition within ±10%, the airflow resistance value should be measured by a predetermined method at a plurality of mutually different points at which the woven fabric 1 does not overlap to confirm whether or not the measured value is within ±10% of the designed value (predetermined reference value). In the present embodiment, the airflow resistance should be measured at at least five points at which the woven fabric 1 does not overlap to confirm that the airflow resistance is within the tolerance range.

The airflow resistance of the woven fabric 1 can be measured using a KES (Kawabata Evaluation System) airflow property tester. The airflow resistance value ([kPa·s/m]) obtained by the KES airflow property tester is a value calculated from a pressure loss value of a test piece (pressure difference between the front side and the back side of the test piece due to the resistance of the test piece measured by the standard measurement at a constant flow rate, for example, 4 cm³/cm²·s) [kPa] measured by a pressure sensor.

### (Airflow Resistance Value)

The airflow resistance value of the woven fabric 1 of the present embodiment can be appropriately determined according to the performance required of the woven fabric, but is preferably 0.3 kPa·s/m or more as measured by the KES airflow property tester described above. This is because the airflow resistance of 0.3 kPa·s/m or more results in a back pressure adjustment function while maintaining the acoustic property required of the woven fabric as a back pressure adjustment member in an acoustic device. The upper limit of the airflow resistance value is not particularly limited, but the airflow resistance value should be 5 kPa·s/m or less in order to secure the back pressure adjustment function (airflow property) in the acoustic device.

### (Thread Diameter)

The woven fabric 1 of the present embodiment preferably has a thread diameter of 30 μm or more. This is because the thread diameter of 30 μm or more provides a woven fabric with high airflow resistance required for adjusting the back pressure. The upper limit of the thread diameter is not particularly limited, but the thread diameter should be 100 μm or less. This is because as the thread diameter increases, the bending angle of the thread at the intersection of the warp thread and the weft thread cannot be reduced, the distance between adjacent threads cannot be reduced and a gap is generated, and a mesh with high airflow resistance cannot be obtained. The thread diameter can be determined by photographing the woven fabric 1 with a microscope from a direction orthogonal to the surface of the woven fabric and performing known image processing on the obtained image. The thread diameter is an average value of the individual thread diameters of the warp threads and the weft threads determined by measuring the diameters of the warp threads and the weft threads at at least five mutually different points in the woven fabric 1.

### (OP)

The woven fabric 1 of the present embodiment preferably has an opening (OP) of 20 μm or less. The opening (OP) is more preferably 18 μm or less. This is because the opening (OP) of 18 μm or less results in a woven fabric with high airflow resistance required of a woven fabric for adjusting the back pressure. The lower limit of the opening has only to be 0 μm or more since it is sufficient that there is a gap (space) at the intersection of the warp thread and the weft thread even if there is no planar opening portion when the woven fabric 1 is viewed from the direction perpendicular thereto as in a dutch woven fabric. In the mesh woven fabric, the opening is the distance between two warp threads adjacent in the weft direction or the distance between two weft threads adjacent in the warp direction when the mesh woven fabric is viewed from the airflow direction and is the length of one side of an opening portion formed in the mesh woven fabric. The opening can be determined from the following formula (1).

$$[ Mathematical formula 1 ]$$

$$OP = ( \frac{25400}{M} ) - D \qquad ( 1 )$$

In the above formula (1), OP is the opening [μm], M is the mesh count [mesh/inch], and D is the diameter [μm] of the warp thread or the weft thread. The mesh count M is the number of threads per 1 inch (2.54 cm) width of the mesh woven fabric. As shown in the above formula (1), the opening OP can be determined from the mesh count M and the diameter D of the thread. When the OPs of the warp and the weft are different, the OP of the warp in the above formula (1) is calculated with the mesh count M being the mesh count in the warp and the thread diameter D being the diameter of the weft thread. The OP of the weft is calculated with the mesh count M being the mesh count in the weft and the thread diameter D being the diameter of the warp thread.

The diameter D of the thread can be determined by photographing the woven fabric 1 with a microscope from a direction orthogonal to the surface of the woven fabric and performing known image processing on the obtained image. The diameter D of the thread is an average value obtained by measuring the diameter of the thread at at least five mutually different points in the woven fabric 1. When the OPs are different between the warp and the weft, and each of the OPs is calculated, the OPs should be measured at five points of each of the warp thread and the weft thread to determine their average values. The diameter D is measured at the middle between adjacent intersections at which the warp thread and the weft thread intersect.

### (OPA)

The woven fabric 1 of the present embodiment preferably has an opening area (OPA) of 15% or less. This is because the opening area of 15% or less provides a woven fabric with high airflow resistance required of a woven fabric for adjusting the back pressure. The lower limit of the opening area has only to be 0% or more since it is sufficient that there is a gap even if there is no planar opening portion as described above. The opening area is an index representing the area rate of the opening portions of the mesh woven fabric and is determined from the following formula (2).

$$[ Mathematical formula 2 ]$$

$$OPA = \frac{{OP}^{2}}{{( OP + D )}^{2}} \times 100 \qquad ( 2 )$$

In the above formula (2), OPA is the opening area [%], OP is the opening [μm], and D is the diameter [μm] of the warp thread or the weft thread. When the OPs of the warp and the weft are different, the OPA is represented by the following formula (3), wherein OP1 is the OP of the warp, OP2 is the OP of the weft, D1 is the diameter of the warp thread, and D2 is the diameter of the weft thread. All of the diameters D, D1, and D2 of the threads are the average values of the diameters described above.

$$[ Mathematical formula 3 ]$$

$$OPA = \frac{OP 1 \times OP 2}{( OP 1 + D 2 ) \times ( OP 2 + D 1 )} \times 100 \qquad ( 3 )$$

### (Material of Thread)

The material of the thread (the warp thread 2 or the weft thread 3) that constitutes the woven fabric 1 can be appropriately determined, but synthetic fibers are preferably used to impart high airflow resistance to the woven fabric for adjusting the back pressure. Since the synthetic fibers have flexibility, the voids 4 formed by the warp threads 2 and the weft threads 3 of the woven fabric 1 can be narrowed, and the airflow resistance of the woven fabric 1 can be increased.

As for the synthetic fibers, for example, polyethylene terephthalate (PET), polypropylene, 6-nylon, 66-nylon, polyethylene, an ethylene-vinyl acetate copolymer, polycarbonate, polyphenylene sulfide (PPS), polyethylene naphthalate (PEN), polyetheretherketone (PEEK), modified polyphenylene ether (PPE), polyaryletherketone (PAEK), polystyrene (PS) including crystalline polystyrene such as syndiotactic polystyrene (SPS) and isotactic polystyrene, and polyimide (PI) can be used.

As for the material of the thread, fluorine-based fibers, fibers formed of thermoplastic resins such as aramid, polyarylate, ultra-high molecular weight polyethylene, polyparaphenylene benzobisoxazole (PBO), polyparaphenylene benzobisthiazole (PBT), polyparaphenylene benzobisimidazole (PBI), polyacetal resin, polyarylate resin, polysulfone resin, polyvinylidene fluoride resin, ethylene tetrafluoroethylene (ETFE), and polytetrafluoroethylene (PTFE), biodegradable resins such as polylactic acid resin, polyhydroxybutyrate resin, modified starch resin, polycaprolactone resin, polybutylene succinate resin, polybutylene adipate terephthalate resin, polybutylene succinate terephthalate resin, and polyethylene succinate resin, thermosetting resins such as phenol resin, urea resin, melamine resin, unsaturated polyester resin, diallyl phthalate resin, epoxy resin, epoxy acrylate resin, silicon resin, acrylic urethane resin, and urethane resin, and elastomers such as silicone resin, polystyrene elastomer, polyethylene elastomer, polypropylene elastomer, and polyurethane elastomer, carbon fibers, and fibers formed of liquid crystal polymers can also be used.

As for the thread that constitutes the woven fabric 1, only one of the above-described fibers may be used, or two or more thereof may be used. The thread may have a core-sheath structure, and the above-described materials can be used as the materials of the core portion and the sheath portion.

Among the above-mentioned synthetic fibers, polyester such as PET and nylon are preferable. This is because these synthetic fibers have appropriate flexibility and elongation, are excellent in weaving properties, and are easy to weave a mesh with high airflow resistance.

### (Form of Fiber)

The thread (the warp thread 2 or the weft thread 3) that constitutes the woven fabric 1 may be a monofilament or a multifilament. For example, both the warp thread 2 and the weft thread 3 may be made of a monofilament or a multifilament, or one of the warp thread 2 and the weft thread 3 may be made of a monofilament and the other may be made of a multifilament.

To increase the airflow resistance of the woven fabric 1, at least one of the warp thread 2 and the weft thread 3 is preferably a multifilament, and more preferably, both the warp thread 2 and the weft thread 3 are multifilaments. This is because the use of the multifilament increases the airflow resistance and is preferable for use for adjusting the back pressure of a diaphragm. This is because the multifilament is more flexible, can narrow the voids 4 more and can increase the airflow resistance of the woven fabric 1 more than the monofilament.

In the present embodiment of the woven fabric 1 including the warp thread 2 or the weft thread 3 that is a multifilament, a non-twisted thread without twists or a twisted thread with twists may be used, but a non-twisted thread is preferably used. This is because, in the case of a non-twisted thread, the variation in the apparent thread diameter, which is the width of the thread when the woven fabric 1 is viewed from the airflow direction thereof, is very small, and the variation in the airflow resistance in the woven fabric 1 is also smaller. The airflow direction is a direction orthogonal to the surface of the woven fabric 1 and is a direction from the front side to the back side of the sheet of FIG. 1. A method of measuring the apparent thread diameter will be described below.

Here, the apparent thread diameter will be described with reference to FIG. 2. FIG. 2 is a drawing illustrating a part of a multifilament thread that constitutes the woven fabric 1 when the woven fabric 1 is viewed from a direction orthogonal to a longitudinal direction of the thread, which is a airflow direction of the woven fabric 1, and FIG. 2(a) illustrates a non-twisted multifilament thread including two single threads (filaments), and FIG. 2(b) illustrates a twisted multifilament thread in which two single threads are twisted. In the case of the non-twisted thread in FIG. 2(a), there is no change in the apparent thread diameter caused by twists, and thus the variation in the thread diameter Wa is very small. On the other hand, in the case of the twisted thread in FIG. 2(b), there are a portion having an apparent thread diameter Wb1 (a portion in which two threads are located on upper and lower sides when the woven fabric 1 is viewed from the airflow direction) and a portion having an apparent thread diameter Wb2 that is smaller than Wb1 (a portion in which two threads overlap front and back when the woven fabric 1 is viewed from the above-mentioned direction), and the variation in the apparent thread diameter is larger in the entire thread than in the case of a non-twisted thread.

As described above, since the multifilament non-twisted thread has a small variation in the apparent thread diameter, a woven fabric 1 with a smaller variation in size and shape of the voids 4 when viewed from a direction parallel to the airflow direction thereof can be formed. The smaller variation in size and the like of the voids 4 results in the formation of a woven fabric with a smaller variation in the airflow resistance.

In the present embodiment of the woven fabric including the thread (the warp thread 2 or the weft thread 3) that is a multifilament, each single thread (filament) that constitutes the multifilament thread has a cross-sectional shape that can be various shapes such as a circular shape, an elliptical shape, and a polygonal shape, but a cross-sectional shape without recesses is preferable. Specifically, any of a circular shape, an elliptical shape, and a polygonal shape in which each internal angle is less than 180 degrees is preferable.

This is because a multifilament formed from filaments with such a cross-sectional shape without recesses has a smaller variation in the apparent thread diameter. On the other hand, as an example of a filament with a recess in a cross-sectional shape, in the case of a filament with a Y-shaped cross section, the filaments may mesh with each other, and a filament may fit into and enter a recess of another filament. The presence of both the portions in which the filament is fitted into and not fitted into a recess results in a variation in the apparent thread diameter (thickness) of the multifilament thread, and consequently, a variation in the airflow resistance. When the shape is other than the Y shape, in the case of a polygonal cross-sectional shape with an internal angle of more than 180 degrees, a filament enters a recess of another filament formed by a corner portion having an internal angle of more than 180 degrees, resulting in a variation in the apparent thread diameter of the multifilament thread and a variation in the airflow resistance.

The above-described cross-sectional shape that is a circular shape or an elliptical shape includes a substantially circular shape or a substantially elliptical shape. A polygonal shape in which each internal angle is less than 180 degrees, that is, an n-gon (n is an integer of 3 or more) such as a triangle or a quadrangle in which all of the internal angles are less than 180 degrees can also be used. The polygonal cross-sectional shape in which each internal angle is less than 180 degrees may also be a substantially polygonal shape in which each corner portion has an R shape (is rounded) having a rounded corner.

### (Variation in Apparent Thread Diameter)

In the present embodiment of the woven fabric 1 including the thread (the warp thread 2 or the weft thread 3) that is a multifilament, the variation in the apparent thread diameter is preferably 5% or less, and more preferably 3% or less. A large variation in the apparent thread diameter results in a variation in the size and shape of the voids 4 formed by the warp threads 2 and the weft threads 3 depending on the portion of the woven fabric 1 to be cut, an increase in the tolerance of the airflow resistance, and consequently, an increase in the variation in the acoustic property.

As described above, the apparent thread diameter is the width (thickness) of the thread when the woven fabric 1 is viewed from the airflow direction thereof (when the woven fabric 1 is viewed from a direction orthogonal to the longitudinal direction of the thread). The apparent thread diameter can be determined by photographing the woven fabric 1 with a microscope from a direction orthogonal to the surface of the woven fabric and performing known image processing on the obtained image.

The variation in the apparent thread diameter in the woven fabric 1 is preferably determined by measuring the apparent thread diameter of each of the warp thread and the weft thread at at least five mutually different points in the woven fabric 1. The apparent thread diameter is measured at the middle between adjacent intersections at which the warp thread and the weft thread intersect. In the present embodiment, the variation in the apparent thread diameter is a value obtained by dividing the absolute value of the difference between the average value of the measured values of the apparent thread diameter and each of the measured values by the average value as expressed by the following formula (4). The variation among the five measurement points is preferably within 5% for both the warp thread and the weft thread.

Variation in apparent thread diameter={absolute value of (measured value−average value)}/average value×100 (4)

As described above, the multifilament thread is preferably a non-twisted thread, but a twisted thread may be used as long as the variation in the apparent thread diameter is within 5%. The variation in the apparent thread diameter within 5% can sufficiently reduce the variation in the airflow resistance. More preferably, the variation in the apparent thread diameter is within 3%. This is because the variation within 3% can further reduce the variation in the airflow resistance.

### (Weave Structure)

As described above, the woven fabric 1 in FIG. 1 shown as an example is plain woven, but the weave structure is not particularly limited thereto. The woven fabric of the present embodiment can be, for example, plain woven, satin woven, twill woven, basket woven, dutch woven, preferably dutch woven (plain dutch woven), twill woven, or twill dutch woven, and more preferably twill dutch woven. In the dutch weave, when the woven fabric is projected from the front, the warp threads are in close contact with each other, and thus there is no opening portion when the woven fabric 1 is viewed from the direction perpendicular to the surface thereof, so that the airflow resistance can be increased. In the dutch weave, when the woven fabric is observed from the cross-sectional direction thereof, there is a gap in a three-dimensionally intersected portion at the intersection of the warp thread and the weft thread, and airflow can be performed through the gap. As an example of twill weave, 2/2 twill weave refers to a weave structure in which warp threads repeatedly pass over two weft threads and then pass under two weft threads, and weft threads repeatedly pass over two warp threads and then pass under two warp threads (in the case of 1/1 twill weave, it is referred to as plain weave). As described above, when the woven fabric is observed from the cross-sectional direction thereof, there is a gap in a three-dimensionally intersected portion at the intersection of the warp thread and the weft thread, and in the case of the twill weave, the number of gaps in the three-dimensionally intersected portion is reduced, so that the airflow resistance can be increased. Use of the twill dutch weave having the advantages of both the twill weave and the dutch weave is more preferable because the airflow resistance can be further increased.

The woven fabric 1 of the present embodiment described above can be used in devices with various acoustic functions, such as earphones, a headphone, a headset, a speaker, a mobile terminal, a PC, a receiver, a hearing aid, and a wearable terminal, each having a airflow portion or a sound passage portion such as a speaker or a microphone.

The woven fabric 1 of the present embodiment described above is a woven fabric that has high airflow resistance capable of adjusting the pressure (back pressure) inside the device, can reduce noise from the outside, can prevent sound leakage to the outside, and has a smaller variation in the acoustic property. According to the present embodiment, it is also possible to provide, in addition to the woven fabric for adjusting the back pressure of a speaker and the like, a woven fabric suitable for an acoustic protection cover, an acoustic waterproof cover, and the like that prevents intrusion of liquid, has a small variation in the acoustic property, and has a stable acoustic property. In addition, since the woven fabric 1 of the present embodiment is a woven fabric with a tolerance of the airflow resistance within ±10%, it is possible to provide an acoustic device with a small variation in the acoustic property depending on the portion to be cut when the woven fabric is cut from a long woven fabric and used, and with stable quality.

### REFERENCE SIGNS LIST

1 woven fabric
2 warp thread
3 weft thread
4 void

1. A woven fabric comprising a warp thread and a weft thread,
the woven fabric having a airflow resistance of 0.3 kPa·s/m or more and 5 kPa·s/m or less, and
the woven fabric having a tolerance of the airflow resistance within ±10%.

2. The woven fabric according to claim 1, wherein at least one of the warp thread and the weft thread is a multifilament thread.

3. The woven fabric according to claim 1, wherein the warp thread and the weft thread are multifilament threads.

4. The woven fabric according to claim 2, wherein the multifilament thread is a non-twisted thread without twists.

5. The woven fabric according to claim 2, wherein a single thread that constitutes the multifilament thread has a cross-sectional shape that is any of a circular shape, an elliptical shape, a polygonal shape in which each internal angle is less than 180 degrees, and a substantially polygonal shape in which each corner of the polygonal shape has an R shape.

6. The woven fabric according to claim 2, wherein a variation in an apparent thread diameter of the multifilament thread when the woven fabric is viewed from a airflow direction thereof is 5% or less.

7. The woven fabric according to claim 1, which is dutch woven, twill woven, or twill dutch woven.

8. The woven fabric according to claim 1, which is used as a woven fabric for adjusting a back pressure of an acoustic device.

9. The woven fabric according to claim 1, wherein the warp thread and the weft thread have a thread diameter of 30 μm or more and 100 μm or less.

10. The woven fabric according to claim 1, having an opening (OP) of 20 μm or less.

11. The woven fabric according to claim 1, having an opening area (OPA) of 15% or less.

12. The woven fabric according to claim 3, wherein the multifilament thread is a non-twisted thread without twists.

13. The woven fabric according to claim 3, wherein a single thread that constitutes the multifilament thread has a cross-sectional shape that is any of a circular shape, an elliptical shape, a polygonal shape in which each internal angle is less than 180 degrees, and a substantially polygonal shape in which each corner of the polygonal shape has an R shape.

14. The woven fabric according to claim 3, wherein a variation in an apparent thread diameter of the multifilament thread when the woven fabric is viewed from a airflow direction thereof is 5% or less.

15. The woven fabric according to claim 2, which is dutch woven, twill woven, or twill dutch woven.

16. The woven fabric according to claim 3, which is dutch woven, twill woven, or twill dutch woven.

17. The woven fabric according to claim 2, which is used as a woven fabric for adjusting a back pressure of an acoustic device.

18. The woven fabric according to claim 3, which is used as a woven fabric for adjusting a back pressure of an acoustic device.
